(19) United States
(12) Patent Application Publication
(10) Pub. No.: US 2010/0153622 A1
(43) Pub. Date: Jun. 17, 2010

(54) Data Access Controller and Data Accessing Method

(75) Inventors: Jie Dai, Shanghai (CN); Chien Chun Shao, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: Semiconductor Manufacturing International (Shanghai) Corporation, Shanghai (CN)

(21) Appl. No.: 12/362,390

(22) Filed: Jan. 29, 2009

(30) Foreign Application Priority Data
Dec. 15, 2008 (CN) 200810204620.1

(51) Int. Cl. G06F 12/02

(52) U.S. Cl. 711/103; 711/E12.008

(57) ABSTRACT

A data access controller and data accessing method is provided. The data access controller includes: a flash memory configuration register unit for storing information used for data access in a flash memory; a flash memory control unit for generating a control signal for data access to a block and a page in the flash memory according to the information used for data access stored in the flash memory configuration register unit; and a temporary memory control unit under the control of the flash memory control unit, adapted to generate a control signal for temporary storage of data. In the inventive solution, data access in the flash memory is under the control of the data access controller, thereby reducing CPU workload, improving operation speed and generality of the control on the data access in flash memory by storing the information for data access for at least one type of flash memory.

### CROSS-REFERENCES TO RELATED APPLICATIONS

The present application claims the priority to Chinese Patent Application No. 200810204620.1, filed Dec. 15, 2008 and entitled “Data Access Controller and Data Accessing Method”, which is hereby incorporated by reference in its entirety.

### FIELD OF THE INVENTION

The present invention relates to a data access controller and a data accessing method.

### BACKGROUND OF THE INVENTION

A flash memory has been widely applied to electronic computers or consumer electronic products such as a personal stereo and an MP3 player. However, a data access control circuit is required to control the data access in the existing flash memory. A typical data access control circuit for the existing flash memory is shown in FIG. 1, and the data access control circuit 1 includes a flash memory control interface 10, a temporary memory 12, a microprocessor 14 and a Direct Memory Access unit 16. The flash memory control interface 10 is connected to a flash memory F to transfer data or instructions required for the data access in the flash memory F, the microprocessor 14 is a center for controlling the data access in the flash memory F, and the Direct Memory Access unit 16 is adapted to perform direct access control for the data access in the flash memory F.

In the above existing control circuit 1, the temporary memory 12 is connected to the flash memory F via the microprocessor 14 and the Direct Memory Access unit 16 during the data access, resulting in a data access latency. Typically, the flash memory operates under the control of a software program. In the control of the software program, codes in the advanced language in the program are required to be converted into machine codes readable to the microprocessor 14. Much space and time resources are required for the microprocessor 14 to calculate and execute various instructions due to the time taken for the code conversion, so that a certain period of time is occupied during the operation of the flash memory.

In addition, a software program generally supports only one type of flash memory and cannot be applied to other types of flash memories. Therefore, when the flash memory in an electronic device needs to be replaced by another type of flash memory due to a failure or upgrade of the electronic device, the software program is required to be updated correspondingly to enable normal operation of the replaced flash memory. As a result, the design cycle is lengthened, the cost is increased and the practical operation becomes relatively complicated, because additional various software programs have to be developed.

### SUMMARY OF THE INVENTION

An aspect of the present invention is to control the data access, to overcome the low data access speed in the prior art.

The object is achieved by a data access controller provided in the present invention, and the controller includes: a flash memory configuration register unit, adapted to store an identification code of at least one type of flash memory, as well as address information, instruction information and access page capacity of the flash memory corresponding to the identification code; a flash memory control unit, adapted to control the data access in the flash memory, generate a control signal for the data access to a block and a page in the flash memory according to the address information and instruction information corresponding to the identification code that are stored in the flash memory configuration register unit, and send to the flash memory the control signal for the data access; and a temporary memory control unit under the control of the flash memory control unit, which is adapted to generate a control signal for temporary storage of data according the control signal for the data access generated by the flash memory control unit and send to the temporary memory the control signal for the temporary storage of data, to instruct the temporary memory to temporarily store the data for the data access in the flash memory.

Optionally, the data access controller further includes: a state enabling unit coupled to the flash memory configuration register unit, which is adapted to down-convert a frequency of a clock signal of the Central Processing Unit (CPU) according to the identification code of the flash memory and the type of the flash memory corresponding to the identification code, to match a frequency of a clock signal in the flash memory.

Optionally, the address information of the flash memory stored in the flash memory configuration register unit is updated during the procedure of data access.

Optionally, the address information includes at least one of block address information and page address information.

Optionally, the flash memory configuration register unit, the state enabling unit, the flash memory control unit and the temporary memory control unit are incorporated into a single integrated circuit.

Optionally, the identification code of the flash memory corresponds one-to-one to the access page capacity and occupies one bit.

Optionally, the instruction information includes at least one of reading the flash memory identification code, reading data, writing data, duplicating data and removing data.

Another aspect of the present invention is to provide a data accessing method, including: reading, by a flash memory control unit, an identification code of a flash memory, and obtaining address information, instruction information and access page capacity of the flash memory corresponding to the identification code from a flash memory configuration register unit; generating and sending, by the flash memory control unit, a control signal for data access to the flash memory during the data access in the flash memory, and generating and sending, by a temporary memory control unit, a control signal for temporary storage of data to the temporary memory according to the control signal for the data access, to instruct the and temporary memory to temporarily store the data for the data access in the flash memory.

Optionally, the data accessing method further includes: before performing the data access, down-converting by a state enabling unit a frequency of a clock signal of the Central Processing Unit according to the identification code of the flash memory and the type of the flash memory corresponding to the identification code, to match the frequency of a clock signal in the flash memory.

Optionally, the data accessing method further includes: updating the address information of the flash memory stored in the flash memory configuration register unit when performing the data access.

Optionally, the address information includes at least one of block address information and page address information.

Optionally, the identification code of the flash memory corresponds one-to-one to the access page capacity and occupies one bit.

Optionally, the instruction information includes at least one of reading the flash memory identification code, reading data, writing data, duplicating data and removing data.

In the inventive solution, the data access in the flash memory is performed under the control of the data access controller, without the participation of the CPU substantially, thereby reducing the workload of the CPU and improving the operation speed relatively. Furthermore, access information of various types of flash memories are stored in the data access controller, and the access information corresponding to the detected type of flash memory may be used to perform the corresponding access operation, thereby improving the generality of the control on the data access in the flash memory.

### BRIEF DESCRIPTION OF THE DRAWINGS

FIG. 1 is a diagram illustrating an architecture of the data access controller in the prior art;

FIG. 2 is a diagram illustrating an architecture of the data access controller according to an embodiment of the present invention; and

FIG. 3 is a flow chart illustrating the data accessing method according to an embodiment of the present invention.

### DETAILED DESCRIPTION OF THE INVENTION

In the data access controller and data accessing method according to embodiments of the present invention, data access in the flash memory is performed under the control of a data access controller, without the participation of the CPU, thereby reducing the workload of the CPU and improving the speed of the data access relatively.

The embodiments of the present invention are described in detail below in connection with the accompanying drawings.

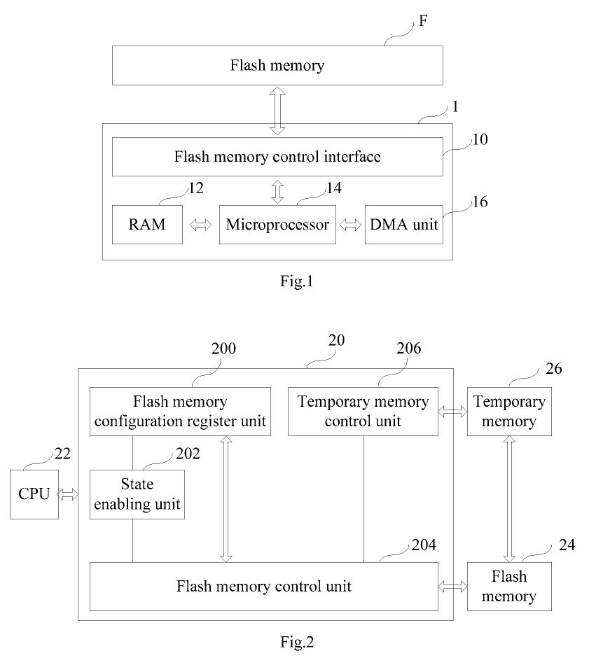

FIG. 2 is a diagram illustrating an architecture of the data access controller according to an embodiment of the present invention. As shown in FIG. 2, a data access controller 20 is coupled to a CPU 22, a flash memory 24 and a temporary memory 26, respectively. The data access controller 20 includes a flash memory configuration register unit 200, a state enabling unit 202, a flash memory control unit 204 and a temporary memory control unit 206. The state enabling unit 202 is coupled to the flash memory configuration register unit 200, the flash memory configuration register unit 200, the state enabling unit 202 and the temporary memory control unit 206 each are coupled to the flash memory control unit 204. The flash memory 24 may be an NOR or NAND flash memory. The temporary memory 26 may be, for example, a Random Access Memory (RAM) or a Direct Access Memory (DMA).

It is noted that the diagram of the architecture of the data access controller as shown in FIG. 2 is only for illustration. In practice, the architecture may further include other lines or interfaces for electrical connections or data conversion and description thereof is omitted herein.

It is noted that the data access controller is provided with a data access execution means. In practice, the data access controller may be arranged in electronic processing devices capable of processing data, such as a computer, a server and a mobile handset (for example, a mobile phone and a Personal Digital Assistant). The flash memory may be either built in the electronic processing device or inserted into the electronic processing device via, for example, an extended interface. In addition, the flash memory configuration register unit 200, the state enabling unit 202, the flash memory control unit 204 and the temporary memory control unit 206 in the data access controller 20 may be, but not limited to be, incorporated into a single integrated circuit. Alternatively, the flash memory configuration register unit 200, the state enabling unit 202, the flash memory control unit 204 and the temporary memory control unit 206 may be separate element devices as long as they can implement their own functions.

The various components above are described in detail below.

The flash memory configuration register unit 200 stores an identification code of at least one type of flash memory, as well as address information, instruction information and access page capacity of the flash memory corresponding to the identification code. In the present embodiment, the address information includes at least one of block address information and page address information. Once the operation of data access is performed, the information stored in the flash memory configuration register unit 200, such as the block address information and the page address information, is updated in time according to changes due to the data access. Further, the instruction information includes at least one of reading the flash memory identification code, reading data, writing data, duplicating data and removing data.

It is noted that the flash memory configuration register unit 200 is not limited to store only one flash memory type. Preferably, when a plurality of flash memory types are stored in the flash memory configuration register unit 200, the flash memory types each are provided with corresponding address information, instruction information and access page capacity. Particularly, in terms of the access page capacity, the identification code for identifying the type of the flash memory may correspond one-to-one to the access page capacity in the format of a form. Take an NAND flash memory as an example, most NAND flash memories with a capacity below 2 Gb (such as NAND128 and NAND256) have a page capacity of (512+16) bytes, while NAND flash memories with a capacity above 2 Gb have a page capacity of (2048+64) bytes. Furthermore, the identification code may occupy one bit, and when the data access controller 20 starts to operate, the flash memory control unit 204 obtains the flash memory type by reading the configured flash memory identification code, to perform initial configuration of the flash memory. Accordingly, access information of various types of flash memories may be stored in the flash memory configuration register unit 200. When the flash memory is replaced with a different type of flash memory (for example, a different type of flash memory card is inserted), according to the updated flash memory type in the flash memory configuration register unit 200, the flash memory control unit 204 obtains the access information corresponding to the updated flash memory type and thereby controls the data access of the updated flash memory. As a result, the application generality of the flash memory is improved in comparison with the prior art where each type of flash memory is provided with a control software.

After the initial configuration of the flash memory is performed by the flash memory control unit 204 in combination with the flash memory configuration register unit 200, the state enabling unit 202 down-converts the frequency of a clock signal of the CPU 22 according to the identification code of the flash memory 24 and the flash memory type corresponding to the identification code, so that the frequency of the down-converted signal matches the frequency of the clock signal in the flash memory 24 or the temporary memory 26, the pulse width for access operations (such as writing and reading) is increased and the speed of the data access is improved.

The flash memory control unit 204 controls the data access in the flash memory. Particularly, the flash memory control unit 204 reads the identification code of the flash memory 24, obtains the access page capacity corresponding to the identification code from the flash memory configuration register unit 200, generates a control signal for accessing the blocks and pages of the flash memory 24 according to the address information and instruction information corresponding to the identification code that are stored in the flash memory configuration register unit 200 after the state enabling unit 202 down-converts the frequency of the clock signal of the CPU 22, and sends the control signal to the flash memory 24. In the present embodiment, the flash memory control unit 204 is a primary component for controlling the data access in the flash memory 24, and all instruction information for controlling the data access in the flash memory 24 are generated and delivered by the flash memory control unit 204. The instruction information includes at least one of reading the flash memory identification code, reading data, writing data, duplicating data and removing data.

Under the control of the flash memory control unit 204, the temporary memory control unit 206 generates control signal for temporary storage of data according the control signal for the data access generated by the flash memory control unit, and sends to the temporary memory 26 the control signal for temporary storage of data, to instruct the temporary memory 26 to temporarily store the data for the data access in the flash memory 24 during the procedure of the data access. In practice, the data includes not only data stored in the flash memory 24 that is to be read, but also data from an external memory or hard disk that is to be written into and stored in the flash memory 24. By means of the intermediate temporary memory control unit 206 and the corresponding temporary memory 26, the data access speed in the flash memory may be improved. However, the technology of temporary storage of data is obvious to the skilled in the art and is not described herein.

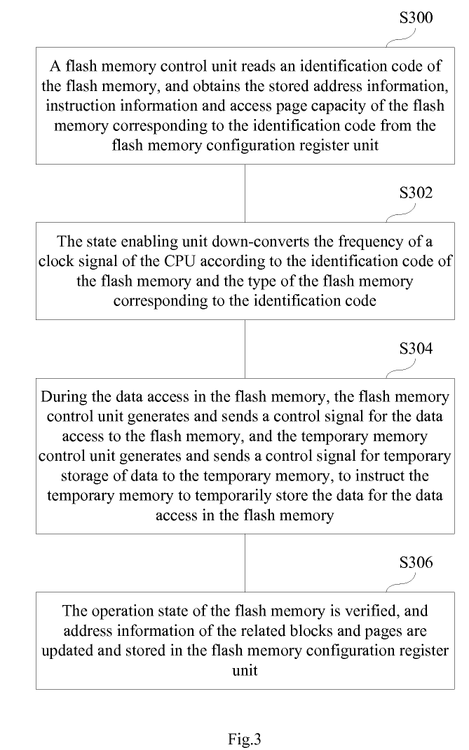

With reference to FIG. 2, the data accessing method according to an embodiment of the present invention as shown in FIG. 3 is described below, and the data accessing method includes the following.

Step S300: A flash memory control unit 204 in the data access controller 20 reads an identification code of a flash memory 24, and obtains the stored address information, instruction information and access page capacity of the flash memory 24 corresponding to the identification code from a flash memory configuration register unit 200. With step S300, all access information of the flash memory 24 may be obtained by reading the configured identification code of the flash memory 24 to perform initial configuration of the flash memory 24, to get ready for the subsequent data access in the flash memory 24. Subsequently, the method proceeds to step S302.

Step S302: The state enabling unit 202 down-converts the frequency of a clock signal of the CPU 22 according to the identification code of the flash memory 24 and the type of the flash memory corresponding to the identification code. Particularly, the frequency of the clock signal of the CPU is generally much higher than that of the clock signal of the flash memory 24 or the temporary memory 26. With the down conversion of the frequency of the clock signal of the CPU 22 according to the identification code of the flash memory 24 and the type of the flash memory corresponding to the identification code, the frequency of the down- converted clock signal may match the frequency of the clock signal of the flash memory 24 or the temporary memory 26, so that the pulse width for access operations (such as writing and reading) is increased and the speed of the data access is improved. Subsequently, the method proceeds to step S304.

Step S304: During the data access in the flash memory 24, the flash memory control unit 204 generates and sends a control signal for the data access to the flash memory 24, and the temporary memory control unit 206 generates a control signal for temporary storage of data according to the control signal for the data access generated by the flash memory control unit and sends the control signal for temporary storage of data to the temporary memory 26, so that the data access in the flash memory 24 is implemented through the cooperation of the flash memory control unit 204 and the temporary memory control unit 206. In the present embodiment, the data access includes at least one of reading the flash memory identification code, reading data, writing data, duplicating data and removing data. In practice, under rules of the data access in the flash memory, data is sequentially written into blocks in the order of pages on the basis of a page. During the removal of data, the data is removed on the basis of a block. During the procedure of data access, the temporary memory 26 is used as a temporary space for temporarily storing the data to be read or written. With the use of the intermediate temporary memory control unit 206 and the corresponding temporary memory 26, the data access speed in the flash memory 24 may be improved. However, the technologies of temporary storage and access of data are obvious to the skilled in the art and are not described herein. Subsequently, the method proceeds to step S306.

Step S306: The operation state of the flash memory 24 is verified, and address information of the related blocks and pages are updated and stored in the flash memory configuration register unit. In the present embodiment, the verification of the operation state of the flash memory 24 refers to verifying the flash memory 24 after one or more operations of data access to determine whether the operations of data access are validated, for example, whether data has been read from the flash memory, data has been written to the flash memory or data in the flash memory has been removed according to the instruction information. The operation state includes, for example, states of operation completed, partial success, a failure, etc. Address information of the blocks and pages in the flash memory 24 may be changed according to the operation states, and stored in flash memory configuration register unit 200 to update the previous address information. The address information can not only indicate the occupied space in the flash memory 24, but also the available space in the flash memory 24, and can further be used as a basis of the access address for the next data access in the flash memory.

Actually, in the present embodiment, the data access controller 20 can be started to operate by the CPU 22. For example, upon detecting insert of an external flash memory card into a computer, the CPU 22 starts the data access controller 20.

In the solutions of the invention, data access in the flash memory is performed with the data access controller, which includes the flash memory configuration register unit, the state enabling unit, the flash memory control unit and the temporary memory control unit. With the use of the data access controller of the architecture described above, the data access is performed without the participation of the CPU substantially, thereby reducing the workload of the CPU and obtaining a higher data access speed than that in the prior art where the data access is performed with the CPU and the flash memory control software.

Furthermore, the data access controller in the inventive solution includes the flash memory configuration register unit in which access information of a plurality of flash memories are stored, and access information corresponding to the detected type of flash memory is adopted and corresponding access operations are performed according to the detected type of flash memory, so that the generality of the control on the data access in the flash memory is improved in comparison with the prior art, where a control software is provided for each type of flash memory so that the control software needs to be replaced due to the replacement of the flash memory, as a result, the design cycle is shortened, the cost is lowered and the operations are simplified.

The invention is described with, but is not limited to, the preferred embodiments described above, and various alternations and modifications can also be made to the invention by those skilled in the art without departing from the scope of the invention. Therefore, the scope of the invention is defined by the appending claims.

1. A data access controller, comprising:
a flash memory configuration register unit, adapted to store an identification code of at least one type of flash memory, and address information, instruction information and access page capacity of the flash memory corresponding to the identification code;
a flash memory control unit, adapted to control data access in the flash memory, generate a control signal for the data access to a block and a page in the flash memory according to the address information and instruction information corresponding to the identification code that are stored in the flash memory configuration register unit, and send to the flash memory the control signal for the data access; and
a temporary memory control unit, which is under the control of the flash memory control unit, adapted to generate a control signal for temporary storage of data according the control signal for the data access generated by the flash memory control unit, and send to the temporary memory the control signal for the temporary storage of data, to instruct the temporary memory to temporarily store the data for the data access in the flash memory.

2. The data access controller of claim 1, further comprising:
a state enabling unit, adapted to down-convert a frequency of a clock signal of a Central Processing Unit according to the identification code of the flash memory and the type of the flash memory to match a frequency of a clock signal in the flash memory.

3. The data access controller of claim 1, wherein the address information of the flash memory stored in the flash memory configuration register unit is updated during a procedure of the data access.

4. The data access controller of claim 1, wherein the address information comprises at least one of block address information and page address information.

5. The data access controller of claim 2, wherein the flash memory configuration register unit, the state enabling unit, the flash memory control unit and the temporary memory control unit are incorporated into a single integrated circuit.

6. The data access controller of claim 1, wherein the identification code of the flash memory corresponds one-to-one to the access page capacity and occupies one bit.

7. The data access controller of claim 1, wherein the instruction information comprises at least one of reading the flash memory identification code, reading data, writing data, duplicating data and removing data.

8. A data accessing method applied in the data access controller of claim 1, comprising:
reading, by a flash memory control unit, an identification code of a flash memory, and obtaining address information, instruction information and access page capacity of the flash memory corresponding to the identification code from a flash memory configuration register unit;
during data access in the flash memory, generating and sending, by the flash memory control unit, a control signal for the data access to the flash memory, generating and sending, by a temporary memory control unit, a control signal for temporary storage of data to the temporary memory according to the control signal for the data access, and temporarily storing the data for the data access in the flash memory using the temporary memory.

9. The data accessing method of claim 8, further comprising:
before performing the data access, down-converting by a state enabling unit a frequency of a clock signal of a Central Processing Unit according to the identification code of the flash memory and the type of the flash memory, to match a frequency of a clock signal in the flash memory.

10. The data accessing method of claim 8, further comprising:
updating the address information of the flash memory stored in the flash memory configuration register unit when performing the data access.

11. The data accessing method of claim 8, wherein the address information comprises at least one of block address information and page address information.

12. The data accessing method of claim 8, wherein the identification code of the flash memory corresponds one-to-one to the access page capacity and occupies one bit.

13. The data accessing method of claim 8, wherein the instruction information comprises at least one of reading the flash memory identification code, reading data, writing data, duplicating data and removing data.
